(19) United States
(12) Patent Application Publication
(10) Pub. No.: US 2009/0039026 A1
(43) Pub. Date: Feb. 12, 2009

(54) Separation method

(75) Inventors: Shintaro Kobayashi, Tokyo (JP); Tomohiko Yoshitake, Tokyo (JP); Tsuneo Okuyama, Kanagawa (JP)

Correspondence Address: GREENBLUM & BERNSTEIN, P.L.C., 1950 ROLAND CLARKE PLACE, RESTON, VA, 20191, US

(73) Assignees: HOYA CORPORATION, Tokyo (JP); Tsuneo OKUYAMA, Kanagawa (JP)

(21) Appl. No.: 12/219,645

(22) Filed: Jul. 25, 2008

(30) Foreign Application Priority Data
Jul. 26, 2007 (JP) 2007-194974

(51) Int. Cl. B01D 15/42

(52) U.S. Cl. 210/665

(57) ABSTRACT

A method of separating at least one phycobilino-based pigment from a sample containing a plurality of phycobilin-based pigments is provided. The method is capable of separating a specific phycobilin-based pigment with high purity by a simple operation.

### FIELD OF THE INVENTION

The present invention relates to a separation method, particularly to a method of separating at least one phycobilin-based pigment from a plurality of phycobilin-based pigments.

### BACKGROUND ART

As a method of detecting an object to be detected with high sensitivity by utilizing an antigen-antibody reaction, an enzyme-linked immunosorbent assay (ELISA) or the like is used.

Such an enzyme-linked immunosorbent assay uses a reagent obtained by, for example, preparing an antibody that can be specifically bonded to an object to be detected (i.e., an antigen) and allowing a fluorescent material as a marker to be carried on (bound to) the antibody.

In recent years, the use of fluorescent proteins contained in, an algae as such fluorescent materials has been contemplated.

For example, JP-A-2003-231821 discloses a method of extracting a fluorescent protein (phycoerythrin) from an algae using a buffer solution.

However, in the case of using the method described in the JP-A-2003-231821, it is difficult to sufficiently prevent fluorescent proteins other than phycoerythrin or proteins other than the fluorescent protein from being contained in an extract.

### SUMMARY OF THE INVENTION

It is an object of the present invention to provide a separation method capable of separating a specific phycobilin-based pigment with high purity by a simple operation.

This object is achieved by the present inventions described below.

A method of separating at least one phycobilin-based pigment from a sample containing a plurality of phycobilin-based pigments, the method comprising: preparing an adsorption apparatus having a filling space for filling an adsorbent having a surface, wherein at least the surface of the adsorbent is constituted of a calcium phosphate-based compound and at least a part of the filling space is filled with the adsorbent; preparing a sample solution by mixing the sample and a phosphate buffer; supplying the sample solution into the filling space of the adsorption apparatus so that the plurality of phycobilin-based pigments are adsorbed by the adsorbent; supplying phosphate elution buffers for eluting at least one of the plurality of phycobilin-based pigments from the adsorbent into the filling space of the adsorption apparatus continuously or in a stepwise manner to thereby obtain an eluant containing the at least one phycobilin-based pigment, the phosphate elution buffers having different salt concentrations; and fractionating the eluant which is discharged from the filling space of the adsorption apparatus into different portions corresponding to the respective phosphate elution buffers to thereby separate the at least one phycobilin-based pigment from the other phycobilin-based pigments.

This makes it possible to separate a specific phycobilin-based pigment with high purity by a simple operation.

In the method described in the above-mentioned item, the method further comprises crystallizing the at least one phycobilin-based pigment by adding a crystallized agent into the eluant.

In the method described in the above-mentioned item, the calcium phosphate-based compound is constituted of hydroxyapatite as a main component thereof.

This also makes it possible to efficiently separate the phicobilin-based pigments from proteins other than the phicobilin-based pigments and easily separate the plurality of phicobilin-based pigments each other.

In the method described in the above-mentioned item, the method, wherein the plurality of phycobilin-based pigments contain R-phycoerythrin, and the phosphate elution buffers include a first phosphate elution buffer of which salt concentration is 1 mM or higher but lower than 25 mM, wherein in the supplying step the first elution phosphate buffer is supplied into the filling space, and then in the fractionating step the R-phycoerythrin is collected from the eluant corresponding to the first elution phosphate buffer.

This also makes it possible to reliably separate the R-phycoerythrin from the other phicobilin-based pigments.

In the method described in the above-mentioned item, the method, wherein the plurality of phycobilin-based pigments contain R-phycoerythrin and phycocyanine, and the phosphate elution buffers include: a first phosphate elution buffer of which salt concentration is 1 mM or higher but lower than 25 mM; and a second phosphate elution buffer of which salt concentration is 25 mM or higher but lower than 75 mM; wherein in the supplying step the first phosphate elution buffer and the second phosphate elution buffer are supplied into the filling space in a stepwise manner in this order, and then in the fractionating step the R-phycoerythrin is collected from the eluant corresponding to the first phosphate elution buffer and the R-phycoerythrin and the phycocyanine are collected from the eluant corresponding to the second phosphate elution buffer in this order.

This also makes it possible to reliably separate the R-phycoerythrin and the phycocyanine from the other phicobilin-based pigments.

In the method described in the above-mentioned item, the method, wherein the plurality of phycobilin-based pigments contain R-phycoerythrin, phycocyanine and allophycocyanine, and the phosphate elution buffers include: a first phosphate elution buffer of which salt concentration is 1 mM or higher but lower than 25 mM; a second phosphate elution buffer of which salt concentration is 25 mM or higher but lower than 75 mM; and a third phosphate elution buffer of which salt concentration is 75 mM or higher but lower than 250 mM; wherein in the supplying step the first phosphate elution buffer, the second phosphate elution buffer and the third phosphate elution buffer are supplied into the filling space in a stepwise manner in this order, and then in the fractionating step the R-phycoerythrin is collected from the eluant corresponding to the first phosphate elution buffer, the R-phycoerythrin and the phycocyanine are collected from the eluant corresponding to the second phosphate elution buffer in this order, and the allophycocyanine is collected from the eluant corresponding to the third phosphate elution buffer.

This also makes it possible to reliably separate the R-phycoerythrin, the phycocyanine and the allophycocyanine from the other phicobilin-based pigments.

In the method described in the above-mentioned item, the method, wherein the plurality of phycobilin-based pigments contain R-phycoerythrin, phycocyanine, allophycocyanine and Y-phycoerythrin, and the phosphate elution buffers include: a first phosphate elution buffer of which salt concentration is 1 mM or higher but lower than 25 mM; a second phosphate elution buffer of which salt concentration is 25 mM or higher but lower than 75 mM; a third phosphate elution buffer of which salt concentration is 75 mM or higher but lower than 250 mM; and a fourth phosphate elution buffer of which salt concentration is 250 mM or higher; wherein in the supplying step the first phosphate elution buffer, the second phosphate elution buffer, the third phosphate elution buffer and the fourth phosphate elution buffer are supplied into the filling space in a stepwise manner in this order, and then in the fractionating step the R-phycoerythrin is collected from the eluant corresponding to the first phosphate elution buffer, the R-phycoerythrin and the phycocyanine are collected from the eluant corresponding to the second phosphate elution buffer in this order, the allophycocyanine is collected from the eluant corresponding to the third phosphate elution buffer, and the Y-phycoerythrin is collected from the eluant corresponding to the fourth phosphate elution buffer.

This also makes it possible to reliably separate the R-phycoerythrin, the phycocyanine, the allophycocyanine and the Y-phycoerythrin from the other phicobilin-based pigments.

In the method described in the above-mentioned item, in the sample solution preparing step the sample solution contains at least one of red algae, blue-green algae, and cryptophyte algae.

This also makes it possible to reliably separate a specific phycobilin-based pigment from the plurality of phicobilin-based pigments contained in the sample prepared by using the red algae, the blue-green algae and the cryptophytes algae.

In the method described in the above-mentioned item, a pH of each of the phosphate elution buffers is in the range of 6 to 8.

This also makes it possible to prevent alteration and degradation of the plurality of phicobilin-based pigments. Further, it is also possible to elute (collect) the phicobilin-based pigments into the phosphate elution buffers.

In the method described in the above-mentioned item, a temperature of each of the phosphate elution buffers is in the range of 30 to 50° C.

This also makes it possible to reliably prevent elution of unwanted proteins into the phosphate elution buffers. In other words, it is possible to improve a collection rate (purity) of a target phicobilin-based pigment.

In the method described in the above-mentioned item, the crystallized agent is constituted of ammonium sulfate as a main component thereof.

This also makes it possible to crystallize the phicobilin-based pigments reliably.

According to the present invention described above, it is possible to separate a specific phycobilin-based pigment (fluorescent protein) with high purity by a simple operation.

Further, according to the present invention described above, it is also possible to reliably separate a target specific phycobilin-based pigment from the other phicobilin-based pigments by appropriately preparing the salt concentration of the phosphate elution buffers.

### BRIEF DESCRIPTION OF THE DRAWINGS

FIG. 1 is a sectional view which shows one example of an adsorption apparatus to be used in the present invention.

FIG. 2 shows absorbance curves which are measured when a plurality of phycobilin-based pigments contained in a sample solution are separated using an adsorption apparatus.

FIG. 3 is partially enlarged view which shows a region (0 to 10 min) in the absorbance curves shown in FIG. 2.

FIG. 4 is partially enlarged view which shows a region to 20 min) in the absorbance curves shown in FIG. 2.

FIG. 5 is partially enlarged view which shows a region to 35 min) in the absorbance curves shown in FIG. 2.

FIG. 6 is partially enlarged view which shows a region to 49 min) in the absorbance curves shown in FIG. 2.

FIG. 7 is partially enlarged view which shows a region to 63 min) in the absorbance curves shown in FIG. 2.

FIG. 8 is a photograph which shows a color of a sample solution and a color of each of fractions.

FIG. 9 shows an absorbance curve of the sample solution shown in FIG. 8.

FIG. 10 shows an absorbance curve of the fraction 2 (F2) shown in FIG. 8.

FIG. 11 shows an absorbance curve of the fraction 7 (F7) shown in FIG. 8.

FIG. 12 shows an absorbance curve of the fraction 17 (F17) shown in FIG. 8.

FIG. 13 shows an absorbance curve of the fraction 18 (F18) shown in FIG. 8.

FIG. 14 shows an absorbance curve of the fraction 32 (F32) shown in FIG. 8.

FIG. 15 shows an absorbance curve of the fraction 33 (F33) shown in FIG. 8.

FIG. 16 shows an absorbance curve of the fraction 33 (F33) (doubling dilution) shown in FIG. 8.

FIG. 17 shows an absorbance curve of the fraction 34 (F34) shown in FIG. 8.

FIG. 18 shows an absorbance curve of the fraction 35 (F35) shown in FIG. 8.

FIG. 19 shows an absorbance curve of the fraction 48 (F48) shown in FIG. 8.

FIG. 20 shows an absorbance curve of the fraction 62 (F62) shown in FIG. 8.

FIG. 21 shows photographs of crystals which are obtained from a sample solution and each of fractions.

### BEST MODE FOR CARRYING OUT THE INVENTION

Hereinbelow, a separation method according to the present invention will be described in detail based on a preferred embodiment shown in the accompanying drawings.

Prior to the description of the separation method according to the present invention, one example of an adsorption apparatus (separation apparatus) to be used in the present invention will be described.

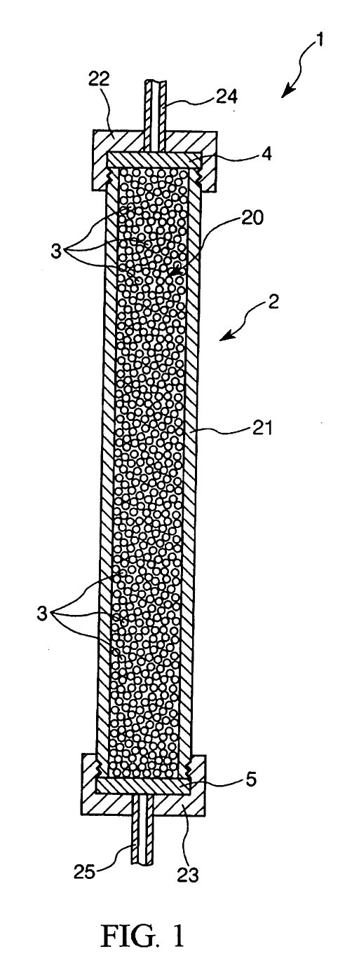

FIG. 1 is a sectional view which shows one example of an adsorption apparatus to be used in the present invention. It is to be noted that in the following description, the upper side and the lower side in FIG. 1 will be referred to as “inflow side” and “outflow side”, respectively.

More specifically, the inflow side means a side from which liquids such as a sample solution (i.e., a liquid containing a sample) and phosphate elution buffers (i.e., eluents) are supplied into the adsorption apparatus to separate (purify) a target phycobilin-based pigment, and the outflow side means a side located on the opposite side from the inflow side, that is, a side through which the liquids described above discharge out of the adsorption apparatus.

The adsorption apparatus 1 shown in FIG. 1 includes a column 2, an adsorbent (filler) 3, and two filter members 4 and 5.

The column 2 is constituted from a column main body 21 and caps 22 and 23 to be attached to the inflow-side end and outflow-side end of the column main body 21, respectively.

The column main body 21 is formed from, for example, a cylindrical member. Examples of a constituent material of each of the parts (members) constituting the column 2 including the column main body 21 include various glass materials, various resin materials, various metal materials, and various ceramic materials and the like.

An opening of the column main body 21 provided on its inflow side is covered with the filter member 4, and in this state, the cap 22 is threadedly mounted on the inflow-side end of the column main body 21. Likewise, an opening of the column main body 21 provided on its outflow side is covered with the filter member 5, and in this state, the cap 23 is threadedly mounted on the outflow-side end of the column main body 21.

The column 2 having such a structure as described above has an adsorbent filling space 20 defined by the column main body 21 and the filter members 4 and 5, and at least a part of the adsorbent filling space 20 is filled with the adsorbent 3 (in this embodiment, almost the entire of the adsorbent filling space 20 is filled with the adsorbent 3).

A volumetric capacity of the adsorbent filling space 20 is appropriately set depending on the volume of a sample solution to be used and is not particularly limited, but is preferably in the range of about 0.05 to 10 mL, and more preferably in the range of about 0.5 to 2 mL per 1 mL of the sample solution.

By setting a size of the adsorbent filling space 20 to a value within the above range and by setting a size of the adsorbent 3 (which will be described later) to a value within a range as will be described later, it is possible to reliably separate a plurality of phycobilin-based pigments from each other.

Further, liquid-tightness between the column main body 21 and the caps 22 and 23 is ensured by attaching the caps 22 and 23 to the column main body 21.

An inlet pipe 24 is liquid-tightly fixed to the cap 22 at substantially the center thereof, and an outlet pipe 25 is also liquid-tightly fixed to the cap 23 at substantially the center thereof. The liquids described above are supplied to the adsorbent filling space 20 through the inlet pipe 24 and the filter member 4. The liquids supplied to the adsorbent filling space 20 pass through gaps between particles of the adsorbent 3 and then discharge out of the column 2 through the filter member 5 and the outlet pipe 25. At this time, the plurality of phycobilin-based pigments contained in the sample solution (sample) are separated based on a difference in degree of adsorption of each of the plurality of phycobilin-based pigments to the adsorbent 3 and a difference in degree of affinity of each of the plurality of phycobilin-based pigments to phosphate elution buffers.

Each of the filter members 4 and 5 has a function of preventing the adsorbent 3 from discharging out of the adsorbent filling space 20. Further, each of the filter members 4 and 5 is formed of a nonwoven fabric, a foam (a sponge-like porous body having communicating pores), a woven fabric, a mesh or the like, which is made of a synthetic resin such as polyurethane, polyvinyl alcohol, polypropylene, polyetherpolyamide, polyethylene terephthalate, or polybutylene terephthalate.

At least a surface of the adsorbent 3 is constituted of a calcium phosphate-based compound. The plurality of phycobilin-based pigments (fluorescent proteins) are specifically adsorbed to such an adsorbent 3. Therefore, the plurality of phycobilin-based pigments are separated from each other based on the difference in degree of adsorption of each of the plurality of phycobilin-based pigments to the adsorbent 3 and the difference in degree of affinity of each of the plurality of phycobilin-based pigments to phosphate elution buffers.

Examples of the calcium phosphate-based compound include, but are not limited thereto, hydroxyapatite (Ca₁₀(PO₄) 6 (OH)₂), TCP(Ca₃ (PO₄)₂), Ca₂P₂O₇, Ca(PO₃)₂, Ca₁₀(PO₄)₆F₂, Ca₁₀(PO₄)₆Cl₂, DCPD (CaHPO₄.2H₂O), Ca₄O(PO₄)₂ and the like. These calcium phosphate-based compounds can be used singly or in combination of two or more of them.

Among these calcium phosphate-based compounds mentioned above, one containing the hydroxyapatite as a main component of the adsorbent 3 is preferred. By using such an adsorbent 3, it is possible to efficiently separate phycobilin-based pigments from other proteins. In addition, by changing a concentration of a salt (phosphate) contained in each of the phosphate elution buffers continuously or in a stepwise manner in such a manner as will be described later, it is also possible to more easily separate a specific phycobilin-based pigment from the other phycobilin-based pigments.

As shown in FIG. 1, the adsorbent 3 preferably has a particulate (granular) shape, but may have another shape such as a pellet (small block)-like shape or a block-like shape (e.g., a porous body in which adjacent pores communicate with each other or a honeycomb shape). By forming the adsorbent 3 having the particulate shape, it is possible to increase its surface area, and thereby improving separation characteristics thereof with respect to the phycobilin-based pigments.

An average particle size of the adsorbent 3 is not particularly limited, but is preferably in the range of about 0.5 to 150 μm, and more preferably in the range of about 10 to 80 μm. By using the adsorbent 3 having such an average particle size, it is possible to reliably prevent clogging of the filter member 5 while a sufficient surface area of the adsorbent 3 is ensured.

It is to be noted that the adsorbent 3 may be entirely constituted of the calcium phosphate-based compound. Alternatively, the adsorbent 3 may be formed by coating the surface of a carrier (base) with the calcium phosphate-based compound.

In a case where almost the entire of the adsorbent filling space 20 is filled with the adsorbent 3 as in the case of this embodiment, the adsorbent 3 preferably has substantially the same composition at every point in the adsorbent filling space 20. This makes it possible to allow the adsorption apparatus 1 to have a particularly excellent ability to separate (purify) the phycobilin-based pigments.

In this regard, it is to be noted that the adsorbent filling space 20 may be partially filled with the adsorbent 3 (e.g., a part of the adsorbent filling space 20 located on its one side where the inlet pipe 24 is provided may be filled with the adsorbent 3). In this case, the remaining part of the adsorbent filling space 20 may be filled with another adsorbent.

Hereinbelow, a method of separating a phycobilin-based pigment using the adsorption apparatus 1 described above (i.e., a separation method according to the present invention) will be described.

(1) Preparation Step

First, a sample containing a plurality of phycobilin-based pigments and a phosphate buffer are mixed to prepare a sample solution.

Examples of the plurality of phycobilin-based pigments include: phycoerythrin such as R-phycoerythrin, Y-phycoerythrin, and B-phycoerythrin; phycocyanine such as C-phycocyanine and allophycocyanine; and the like. In this embodiment, a sample containing R-phycoerythrin, Y-phycoerythrin, phycocyanine, and allophycocyanine is used as one example of the sample containing the plurality of phycobilin-based pigments.

Examples of the sample for extracting such plurality of phycobilin-based pigments include a red algae, a blue-green algae, a cryptophyte algae and the like. These samples can be used singly or in combination of two or more of them. By using the separation method according to the present invention, it is possible to reliably separate a specific phycobilin-based pigment from the other phycobilin-based pigments.

Further, such a sample may be directly used (as a raw sample) or may be dried by, for example, freeze drying and, if necessary, further may be ground before use.

Examples of the phosphate buffer include sodium phosphate, potassium phosphate, lithium phosphate and the like.

A concentration of a salt (phosphate) contained in the phosphate buffer to be used for preparing the sample solution is preferably equal to or lower than that of a first phosphate elution buffer (which will be described later). This makes it possible to more reliably remove unnecessary proteins from a prepared sample solution.

An amount of the phosphate buffer to be used for preparing the sample solution is not particularly limited, but is preferably in the range of about 5 to 300 times, and more preferably in the range of about 50 to 150 times with respect to the mass of the used sample.

A pH of the phosphate buffer is not particularly limited, but is preferably in the range of about 6 to 8, and more preferably in the range of about 6.5 to 7.5.

A temperature of the phosphate buffer is not particularly limited either, but is preferably in the range of about 30 to 50° C., and more preferably in the range of about 35 to 45° C.

By using the phosphate buffer having the pH within the above range and the temperature within the above range, it is possible to more reliably elute (extract) the phycobilin-based pigments into phosphate elution buffers or to more reliably desorb the phycobilin-based pigments from the adsorbent 3 to the phosphate elution buffers. Therefore, it is possible to improve a collection rate of a target phycobilin-based pigment.

It is to be noted that in a case where the thus prepared sample solution contains solid matters, the solid matters are preferably removed from the sample solution. By doing so, it is possible to reliably prevent clogging of the column 2. A method of removing the solid matters is not particularly limited. For example, the sample solution may be centrifuged to obtain a supernatant. In this case, the obtained supernatant is collected, and then the solid matters remaining in the supernatant is further removed by filtration using a filter.

(2) Supplying Step

Next, the sample solution is supplied to the adsorbent filling space 20 through the inlet pipe 24 and the filter member 4 to be in contact with the adsorbent 3 and to pass through the column 2 (adsorbent filling space 20).

As a result, components having a low adsorbability to the adsorbent 3 (e.g., proteins other than the phycobilin-based pigments) are discharged out of the column 2 through the filter member 5 and the outlet pipe 25. On the other hand, the phycobilin-based pigments having a high adsorbability to the adsorbent 3 and proteins which are not phycobilin-based pigments but have a relatively high adsorbability to the adsorbent 3 are retained to the adsorbent 3 in the adsorbent filling space 20 of the column 2.

(3) Fractionation Step

Next, phosphate elution buffers are supplied into the adsorbent filling space 20 (column 2) through the inlet pipe 24 and the filter member 4 to elute the phycobilin-based pigments, and thereby an eluant (eluate) containing the phosphate elution buffers and the phycobilin-based pigments can be obtained. Thereafter, the eluant discharged out of the column 2 through the outlet pipe 25 and the filler member 5 is fractionated (collected) to obtain fractions corresponding to the respective phosphate elution buffers each having a predetermined amount of the eluant.

According to the present invention, a concentration of a salt (phosphate) (salt concentration) contained in each of the phosphate elution buffers is changed continuously or in a stepwise manner. In this regard, it is to be noted that each of the phosphate elution buffers is preferably of the same kind as that of the phosphate buffer used in the preparation step described above.

When the phosphate elution buffers are brought into contact with the adsorbent 3, to which the plurality of phycobilin-based pigments and proteins other than the plurality of phycobilin-based pigments are being adsorbed, the proteins which are not phycobilin-based pigments and have a lower adsorbability to the adsorbent 3 than the plurality of phycobilin-based pigments are first desorbed from the adsorbent 3, and then discharged through the outlet pipe 25. Then, the plurality of phycobilin-based pigments adsorbed to the adsorbent 3 are desorbed from the adsorbent 3 by changing the salt concentration of each of the phosphate elution buffers depending on the kind of phycobilin-based pigments. The phycobilin-based pigments desorbed from the adsorbent 3 are mixed with the phosphate elution buffers to obtain an eluant, and then the phycobilin-based pigments are collected from the eluant discharged through the outlet pipe 25. At this time, by fractionating the eluant discharged through the outlet pipe 25 into fractions each having a predetermined amount, it is possible to separate a specific phycobilin-based pigment from the sample solution containing the plurality of phycobilin-based pigments.

That is, at least one of R-phycoerythrin, phycocyanine, allophycocyanine, and Y-phycoerythrin can be separated from the sample solution containing the plurality of phycobilin-based pigments.

As described above, according to the present invention, the salt concentration of each of the phosphate elution buffers is changed continuously or in a stepwise manner. In this embodiment, it is preferred that a first phosphate elution buffer containing a salt having a concentration of 1 mM or more but less than 25 mM, a second phosphate elution buffer containing a salt having a concentration of 25 mM or more but less than 75 mM, a third phosphate elution buffer containing a salt having a concentration of 75 mM or more but less than 250 mM, and a fourth phosphate elution buffer containing a salt having a concentration of 250 mM or more are supplied in the order listed into the adsorbent filling space 20 of the column 2 in a stepwise manner.

In this case, R-phycoerythrin is collected from the eluant corresponding to the first phosphate elution buffer, R-phycoerythrin and phycocyanine are collected from the eluant corresponding to the second phosphate elution buffer, allophycocyanine is collected from the eluant corresponding to the third phosphate elution buffer, and Y-phycoerythrin is collected from the eluant corresponding to the fourth phosphate elution buffer.

It is to be noted that the salt concentration of the first phosphate elution buffer is more preferably in the range of about 1 to 10 mM, the salt concentration of the second phosphate elution buffer is more preferably in the range of about 35 to 65 mM, the salt concentration of the third phosphate elution buffer is more preferably in the range of about 85 to 125 mM, and the salt concentration of the fourth phosphate elution buffer is more preferably in the range of about 450 to 650 mM. Further, the salt concentration of the first phosphate elution buffer is even more preferably in the range of about 1 to 5 mM, the salt concentration of the second phosphate elution buffer is even more preferably in the range of about 45 to 55 mM, the salt concentration of the third phosphate elution buffer is even more preferably in the range of about 95 to 105 mM, and the salt concentration of the fourth phosphate elution buffer is even more preferably in the range of about 490 to 510 mM.

By supplying these phosphate elution buffers containing the salts having such concentrations into the column 2 in a stepwise manner, it is possible to more reliably separate a target phycobilin-based pigment from the other phycobilin-based pigments.

A pH of each of the first to fourth phosphate elution buffers is preferably in the range of about 6 to 8, and more preferably in the range of about 6.5 to 7.5. By setting the pH of each of the first to fourth phosphate elution buffers to a value within the above range, it is possible to more reliably elute (collect) the phycobilin-based pigments into the phosphate elution buffers while alteration or degradation of the phycobilin-based pigments is prevented.

A temperature of each of the first to fourth phosphate elution buffers is preferably in the range of about 30 to 50° C., and more preferably in the range of about 35 to 45° C. By setting the temperature of each of the first to fourth phosphate elution buffers to a value within the above range, it is possible to more reliably prevent the elution of unnecessary proteins into the phosphate elution buffers. Therefore, it is possible to further improve a collection rate (purity) of a target phycobilin-based pigment.

A flow rate at which each of the first to fourth phosphate elution buffers flows in adsorbent filling space 20 of the column 2 is not particularly limited, but is preferably in the range of about 1 to 10 mL/min, and more preferably in the range of about 1 to 5 mL/min.

A flow time at which each of the first to fourth phosphate elution buffers flows in adsorbent filling space 20 of the column 2 is not particularly limited, but is preferably in the range of about 5 to 60 minutes, and more preferably in the range of about 10 to 30 minutes.

(4) Crystallization Step

Next, a crystallizing agent is added to the eluant of the fractions to crystallize the phycobilin-based pigments. By doing so, it is possible to easily collect a target phycobilin-based pigment with high purity.

The crystallizing agent is not particularly limited, but one mainly containing ammonium sulfate is preferably used. By using such a crystallizing agent, it is possible to reliably crystallize the phycobilin-based pigments while alteration or degradation of the phycobilin-based pigments is prevented.

An amount of the crystallizing agent to be added to the flactionated eluant is appropriately set so that a concentration of the crystallizing agent in the flactionated eluant becomes preferably in the range of about 30 to 90% of its saturated concentration, and more preferably in the range of about 40 to 60% of its saturated concentration.

It is to be noted that the crystallizing agent may be directly added to the fractionated eluant, or may be added to the fractionated eluant in the form of a solution in an appropriate solvent.

As described above, in this embodiment, the four phosphate elution buffers, that is, the first to fourth phosphate elution buffers are prepared and supplied into the adsorbent filling space 20 of the column 2 in the order listed. However, for example, in a case where selective collection of R-phycoerythrin is desired, two phosphate elution buffers, that is, the first phosphate elution buffer and another phosphate elution buffer containing a salt having a higher concentration than the salt concentration of the first phosphate elution buffer may be prepared and supplied into the adsorbent filling space 20 of the column 2 in the order listed. In this case, the second to fourth phosphate elution buffers may be supplied into the adsorbent filling space 20 of the column 2 after the two phosphate elution buffers described above are supplied into the adsorbent filling space 20 of the column 2.

Further, the first to fourth phosphate elution buffers may be used in combination of two or more of them depending on the kind of target phycobilin-based pigment to be collected.

For example, the first phosphate elution buffer and the second phosphate elution buffer may be used in combination. In this case, R-phycoerythrin is collected from an eluant (first phosphate elution buffer) discharged out of the column 2 during the discharge of the first phosphate elution buffer out the column 2, and R-phycoerythrin and phycocyanine are collected from an eluant (second phosphate elution buffer) discharged out of the column 2 during the discharge of the second phosphate elution buffer out the column 2.

Further, the first, second, and third phosphate elution buffers may be used in combination. In this case, R-phycoerythrin is collected from an eluant (first phosphate elution buffer) discharged out of the column 2 during the discharge of the first phosphate elution buffer out the column 2, R-phycoerythrin and phycocyanine are collected from an eluant (second phosphate elution buffer) discharged out of the column 2 during the discharge of the second phosphate elution buffer out the column 2, and allophycocyanine is collected from an eluant (third phosphate elution buffer) discharged out of the column 2 during the discharge of the third phosphate elution buffer out the column 2.

As described above, by using the separation method according to the present invention, it is possible to eliminate the necessity to change the adsorption apparatus such as a column depending on the kind of phycobilin-based pigment to be separated in order to separate a specific phycobilin-based pigment from a sample containing the plurality of phycobilin-based pigments. In addition, it is also possible to separate a specific phycobilin-based pigment by such a simple operation that the salt concentration of each of phosphate elution buffers supplied into the adsorption apparatus is changed continuously or in a stepwise manner.

Although the separation method according to the present invention has been described above with reference to a preferred embodiment thereof, the present invention is not limited thereto. For example, the separation method according to the present invention may further include one or more steps for any purpose.

Further, the embodiment of the present invention has been described based on a case where the column having the adsorbent filling space filled with the adsorbent (filler) is used as the adsorption apparatus, but an adsorption apparatus having, for example, a flat plate-shaped adsorbent received therein may also be used.

### EXAMPLES

Hereinbelow, the present invention will be described with reference to specific examples.

### Example 1

1 First, 1 g of dried seaweed was prepared as a sample, and the sample was ground into powder using a grinder.

2 Then, a 1 mM phosphate buffer (pH 7.0) was added to the powder, and the phosphate buffer and the powder were stirred at 37° C. for 24 hours to obtain a mixture.

3 After the completion of stirring, the mixture was centrifuged (2,000 rpm×5 min) to collect a supernatant. The supernatant was allowed to pass through a filter having an average pore size of 0.4 μm to obtain a sample solution.

4 Then, 60 mL of the sample solution (Sample) was supplied into a Bio-rad Bio-scale column MT5 (adsorption apparatus) at a rate of 2 mL/min for 30 minutes. It is to be noted that a volumetric capacity of a adsorbent filling space of the column was 5 mL.

As a filling material for filling the adsorbent filling space of the column, calcium hydroxyapatite beads (Ca-HAP) (particle size: 40 μm, Type-II, produced by Pentax Corporation) were used. It is to be noted that calcium hydroxyapatite beads (Ca-HAP) are normal hydroxyapatite beads which Ca is not substituted by another metal element.

5 Then, a 1 mM phosphate elution buffer (sodium phosphate: pH 7.0) and a 5 mM phosphate elution buffer (pH 7.0) were prepared as a first phosphate elution buffer, a 50 mM phosphate elution buffer (pH 7.0) was prepared as a second phosphate elution buffer, a 100 mM phosphate elution buffer (pH 7.0) was prepared as a third phosphate elution buffer, and a 500 mM phosphate elution buffer (pH 7.0) was prepared as a fourth phosphate elution buffer. Each of the first to fourth phosphate elution buffers (60 mL) was supplied into the adsorbent filling space of the column in the order listed at 4 mL/min for 15 minutes. Then, an eluant discharged out of the column was fractionated to collect 4 mL fractions (every 1 minute).

It is to be noted that a 4 mL eluant fraction collected first was numbered F1, and other 4 mL eluant fractions sequentially collected were also numbered. More specifically, an eluant collected during the discharge of the 1 mM phosphate elution buffer was fractionated into 15 fractions numbered F1 to F15, an eluant collected during the discharge of the 5 mM phosphate elution buffer was fractionated into 15 fractions numbered F16 to F30, an eluant collected during the discharge of the 50 mM phosphate elution buffer was fractioned into 15 fractions numbered F31 to F45, an eluant collected during the discharge of the 100 mM phosphate elution buffer was fractionated into 15 fractions numbered F46 to F60, and an eluant collected during the discharge of the 500 mM phosphate elution buffer was fractionated into 15 fractions numbered F61 to F75. The eluant in each of the fractions was subjected to a visible-ultraviolet spectrophotometer.

6 Then, a 50 wt % aqueous ammonium sulfate solution was added to the eluant in each of fractions to crystallize phycobilin-based pigments.

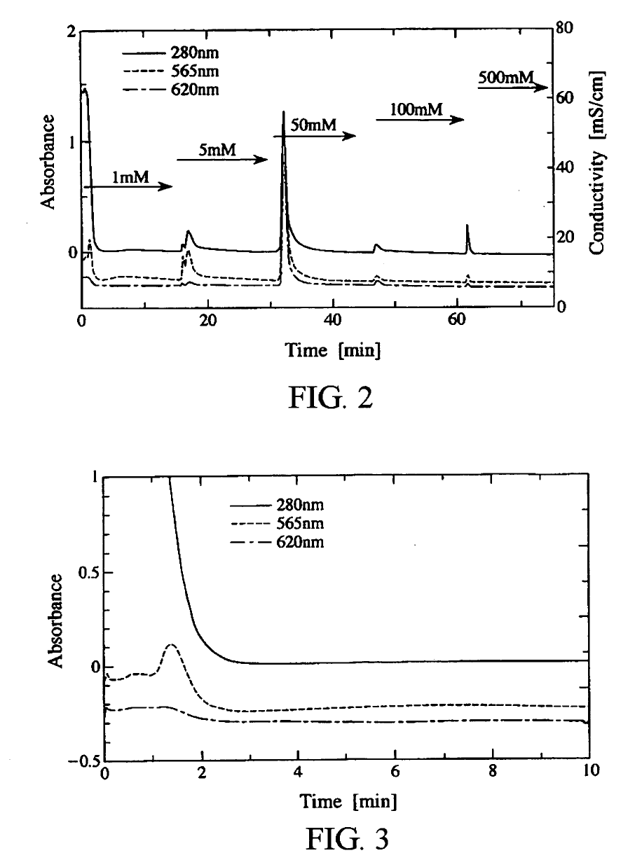

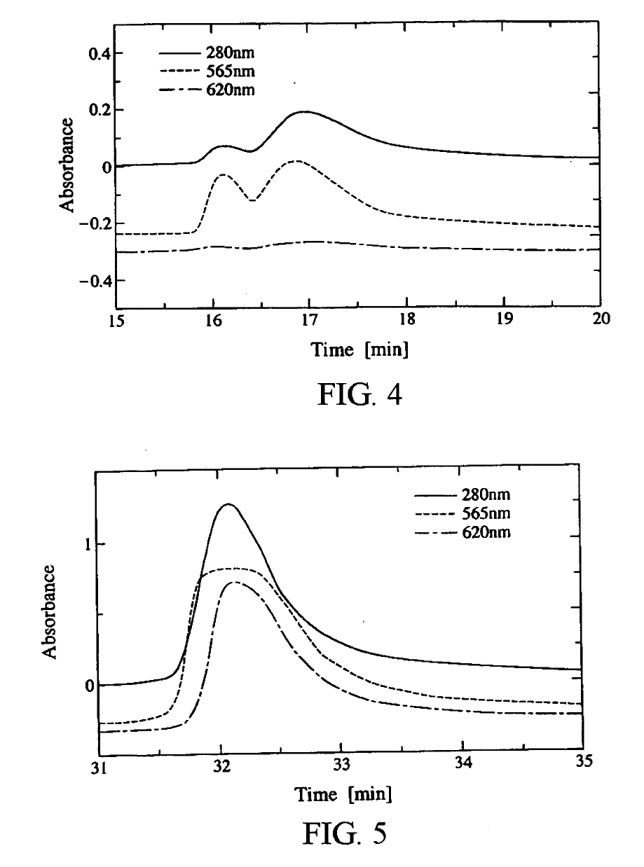

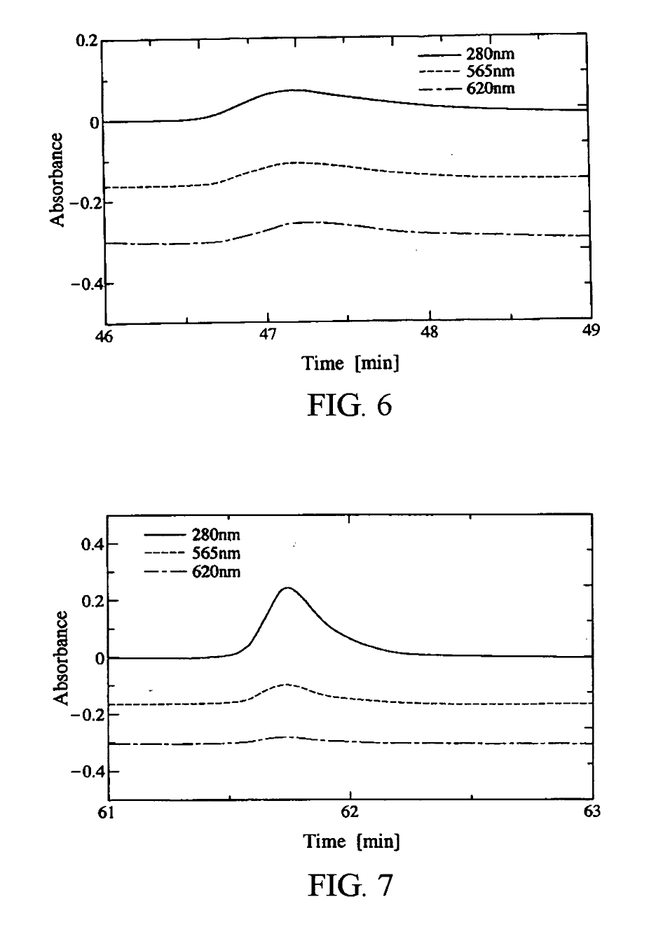

FIG. 2 shows absorbance curves which are measured when the plurality of phycobilin-based pigments contained in the sample solution were separated using the adsorption apparatus in the above step 5. FIGS. 3 to 7 are partially enlarged views which show some regions in the absorbance curves shown in FIG. 2 where a change in absorbance has been detected.

As can be seen from the absorbance curves shown in FIG. 2 and FIGS. 3 to 7, a change in absorbance was detected in at least one of the absorbance curves measured at wavelengths of 565 nm and 620 nm when the absorbances of the fraction F2 (in each drawing, during the time period from 1 to 2 min), the fraction F7 (in each drawing, during the time period from 6 to 7 min), the fraction F17 (in each drawing, during the time period from 16 to 17 min), the fraction F18 (in each drawing, during the time period from 17 to 18 min), the fraction F32 (in each drawing, during the time period from 31 to 32 min), the fraction F33 (in each drawing, during the time period from 32 to 33 min), the fraction F34 (in each drawing, during the time period from 33 to 34 min), the fraction F35 (in each drawing, during the time period from 34 to 35 min), the fraction F48 (in each drawing, during the time period from 47 to 48 min), and the fraction F62 (in each drawing, during the time period from 61 to 62 min) were measured at the wavelengths of 280 nm, 565 nm and 620 nm.

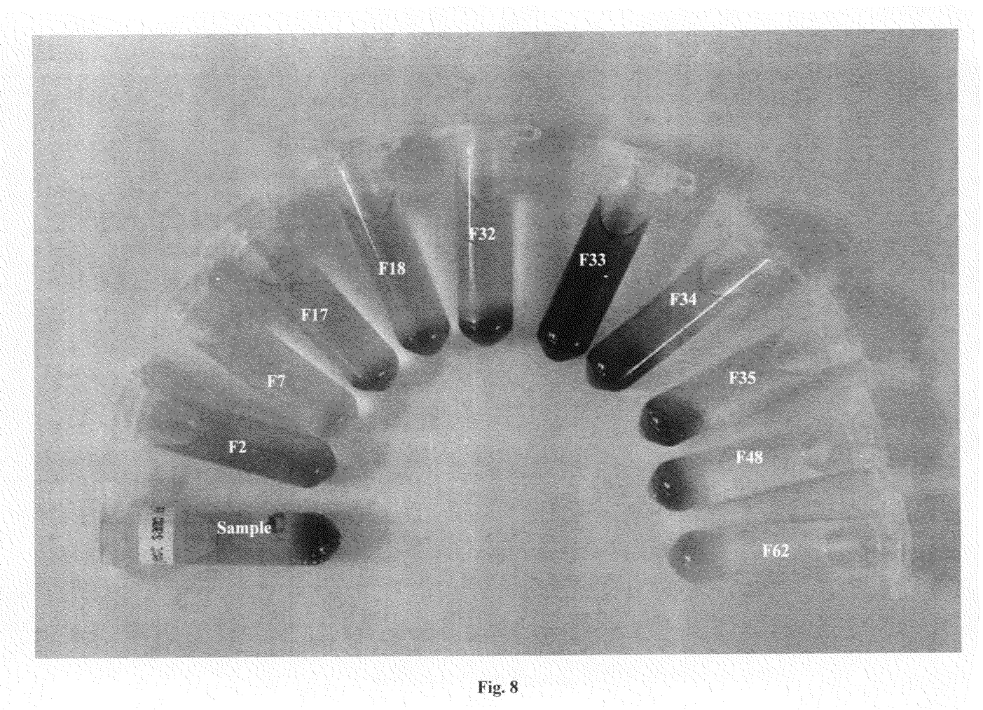

FIG. 8 is a photograph which shows a color of the sample solution (Sample) and a color of each of the fractions exhibiting a change in absorbance.

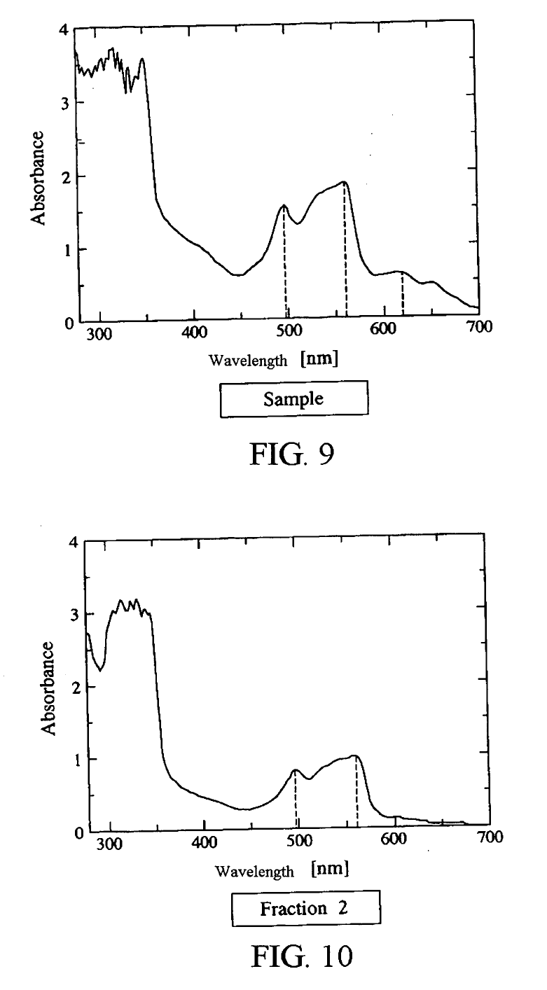

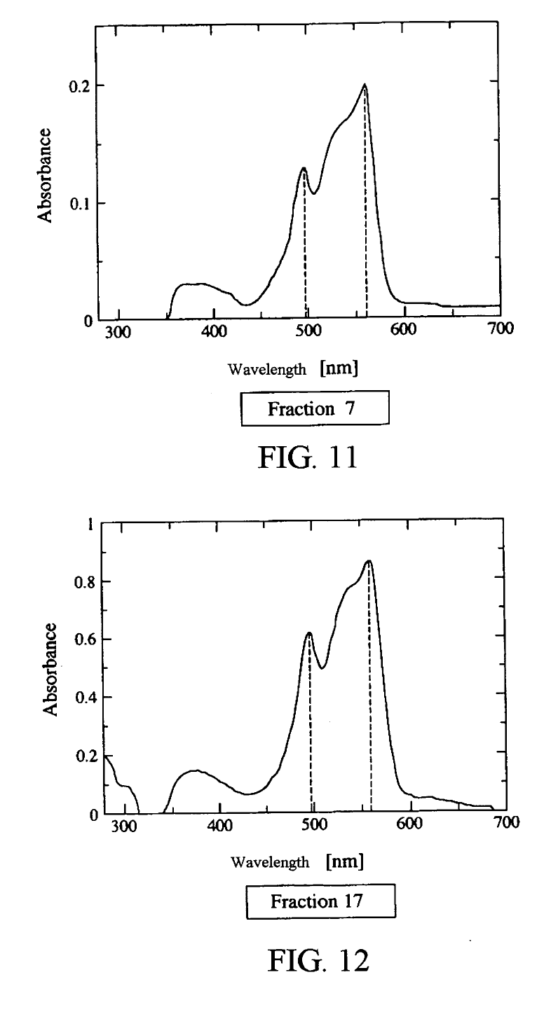

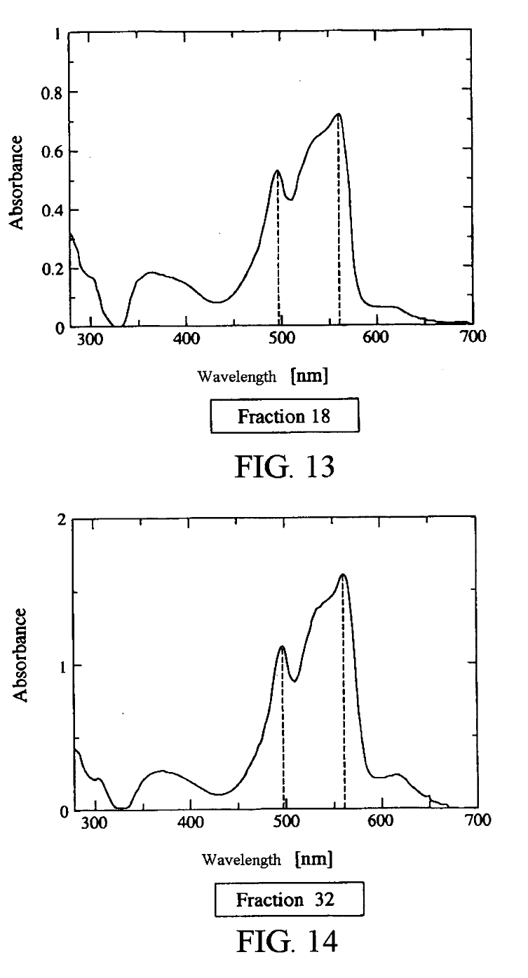

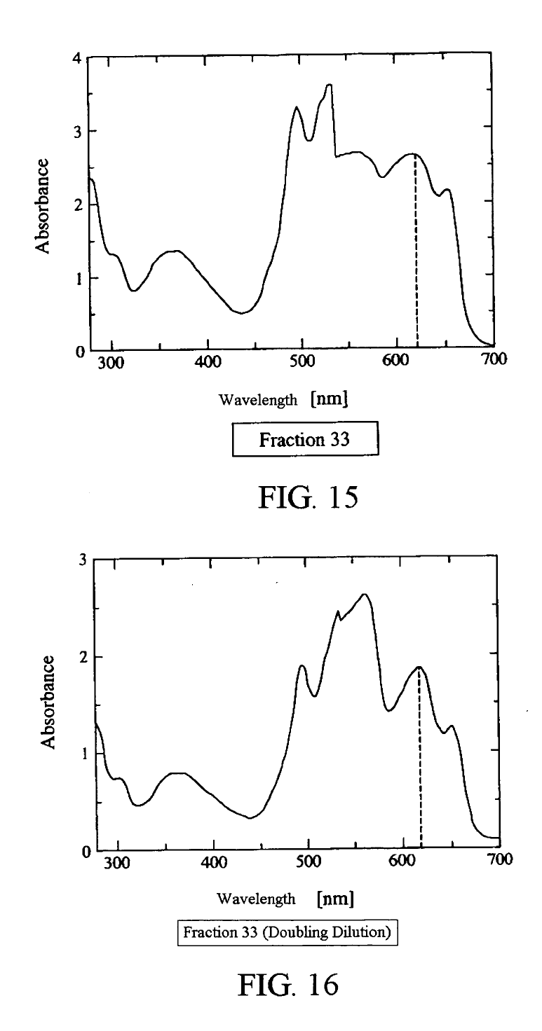

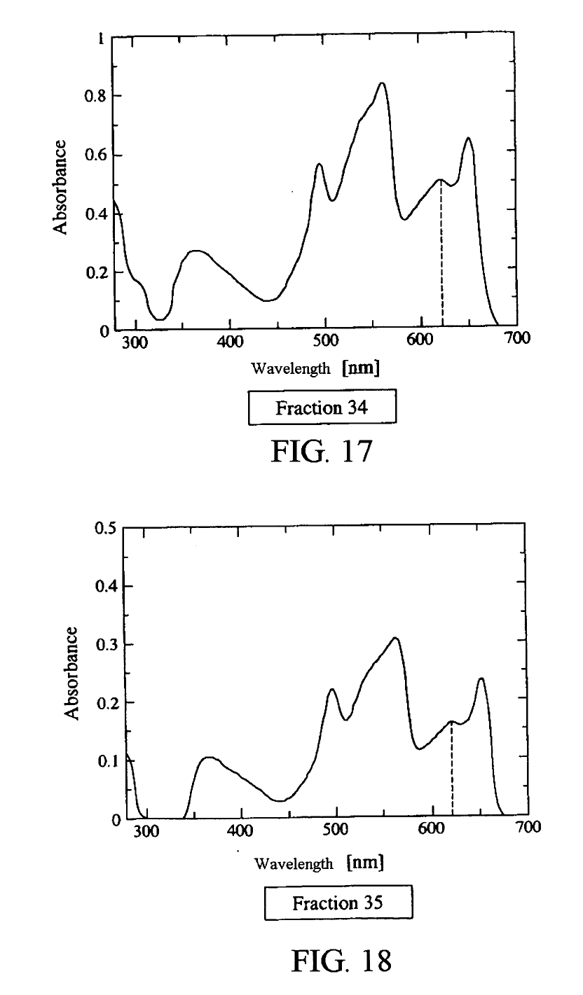

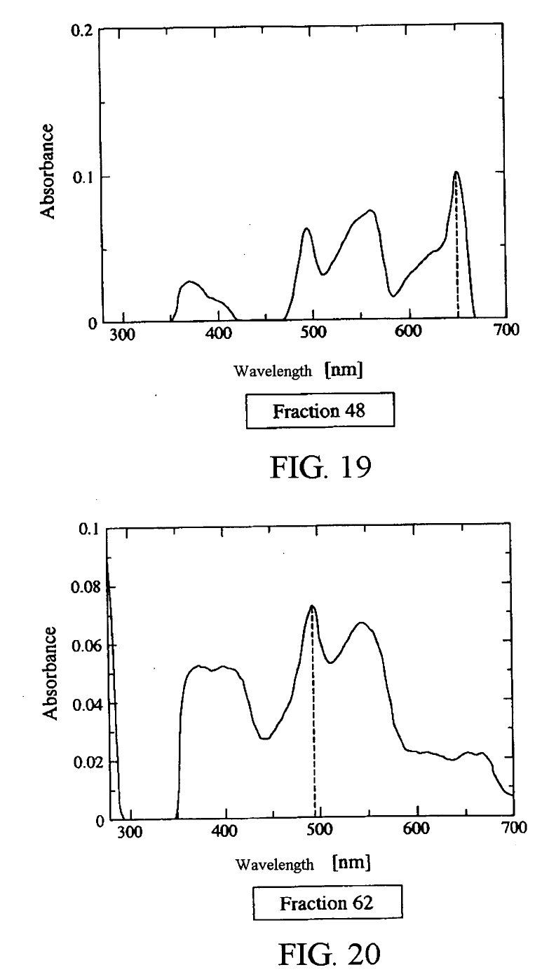

Further, FIGS. 9 to 20 show absorbance curves of the sample solution and the fractions shown in FIG. 8 measured at the wavelengths from 300 to 700 nm.

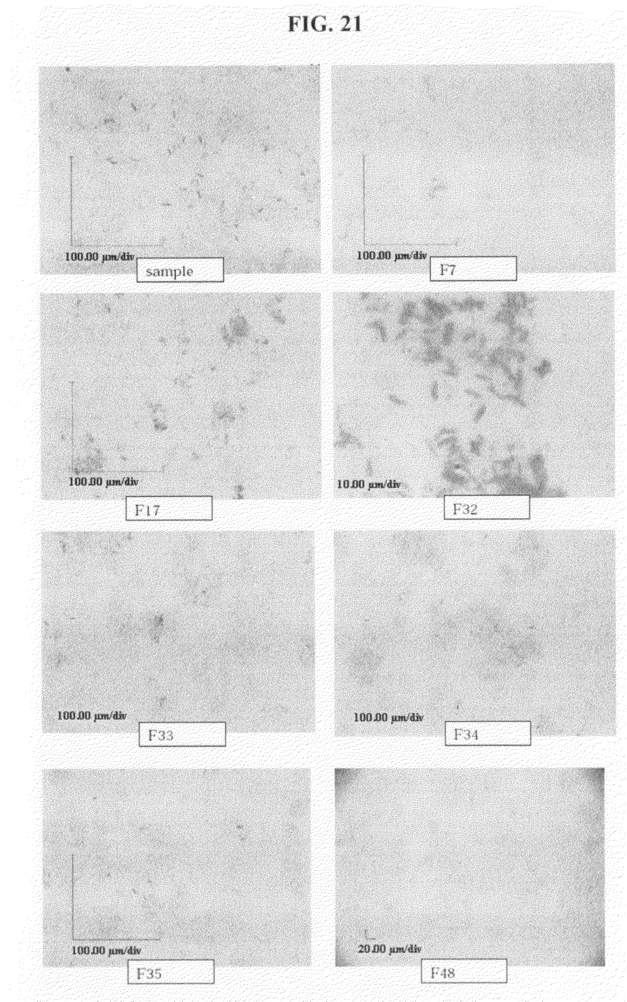

Furthermore, FIG. 21 shows photographs of crystals which are obtained by adding a 50 wt % aqueous ammonium sulfate solution to each of the sample solution (Sample) and some fractions fractionated in the step 5 (i.e., the fractions F7, F17, F32, F33, F34, F35, and F48).

As shown in FIG. 8, the fractions F2, F7, F17, and F18 showed a red color, the fraction F32 showed a slightly bluish-red color, the fractions F33, F34, F35, and F48 showed a bluish-purple color, and the fraction F62 showed a red color.

As shown in FIGS. 9 to 20, in each of the cases of the fractions F2, F7, F17, F18, and F32, peaks were detected at about 495 nm and 565 nm, and in each of the cases of the fractions F33, F34, and F35, a peak was detected at about 620 nm. Further, in the case of the fraction F48, a peak detected at about 650 nm was a main peak, and in the case of the fraction F62, a peak detected at about 495 nm was a main peak.

The phycobilin-based pigment having absorption peaks at about 495 nm (second peak) and about 565 nm (main peak) was R-phycoerythrin showing a red color. The phycobilin-based pigment having an absorption peak at about 620 nm was phycocyanine showing a blue color. The phycobilin-based pigment having a main peak at about 650 nm was allophycocyanine showing a blue color. The phycobilin-based pigment having a main peak at about 495 nm was Y-phycoerythrin showing a red color.

As can be seen from the results shown in FIG. 8 and FIGS. 9 to 20, R-phycoerythrin could be collected from the eluant (fractions F2, F7, F17, and F18) discharged out of the adsorption apparatus during the discharge of the 1 mM phosphate elution buffer and the 5 mM phosphate elution buffer (i.e., the first phosphate elution buffers) from the adsorption apparatus, R-phycoerythrin and phycocyanine could be collected from the eluant (R-phycoerythrin: fraction F32, phycocyanine: fractions F33, F34, and F35) discharged out of the adsorption apparatus during the discharge of the 50 mM phosphate elution buffer (i.e., the second phosphate elution buffer) from the adsorption apparatus, allophycocyanine could be collected from the eluant (fraction F48) discharged out of the adsorption apparatus during the discharge of the 100 mM phosphate elution buffer (i.e., the third phosphate elution buffer) from the adsorption apparatus, and Y-phycoerythrin could be collected from the eluant (fraction F62) discharged out of the adsorption apparatus during the discharge of the 500 mM phosphate elution buffer (i.e., the fourth phosphate elution buffer) from the adsorption apparatus.

Further, as shown in FIG. 21, all the phycobilin-based pigments were obtained as pure crystals although some photographs shown in FIG. 21 are not clear due to a limited absolute amount of the crystals.

### Example 2

The separation of phycobilin-based pigments was carried out in the same manner as in the Example 1 except that the size of the adsorption apparatus was increased (i.e., except that the adsorption apparatus was scaled-up).

As a result, the phycobilin-based pigments could be separated as in the case of the Example 1.

It is to be noted that in the Example 2, a Bio-rad geltec column (diameter: 20 cm, length: 10 cm) was used as an adsorption apparatus, and CHT type-2 (average particle size: 60 μm) was used as a filler (adsorbent).

Further, separation of phycobilin-based pigments was carried out in the same manner as in the Example 1 and the Example except that the length of the column was increased. In both cases, R-phycoerythrin and phycocyanine tended to be more clearly separated from each other in a 50 mM phosphate buffer (i.e., a second phosphate elution buffer).

Further, it is also to be understood that the present disclosure relates to subject matter contained in Japanese Patent Application No. 2007-194974 (filed on Jul. 26, 2007) which is expressly incorporated herein by reference in its entireties.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. A method of separating at least one phycobilin-based pigment from a sample containing a plurality of phycobilin-based pigments, the method comprising:
preparing an adsorption apparatus having a filling space that fills an adsorbent having a surface,
wherein at least the surface of the adsorbent is constituted of a calcium phosphate-based compound and at least a part of the filling space is filled with the adsorbent;
preparing a sample solution by mixing the sample and a phosphate buffer;
supplying the sample solution into the filling space of the adsorption apparatus so that the plurality of phycobilin-based pigments are adsorbed by the adsorbent;
supplying phosphate elution buffers that elute at least one of the plurality of phycobilin-based pigments from the adsorbent into the filling space of the adsorption apparatus continuously or in a stepwise manner to thereby obtain an eluant containing the at least one phycobilin-based pigment, the phosphate elution buffers having different salt concentrations; and
fractionating the eluant which is discharged from the filling space of the adsorption apparatus into different portions corresponding to respective phosphate elution buffers to thereby separate the at least one phycobilin-based pigment from other phycobilin-based pigments.

2. The method as claimed in claim 1, further comprising crystallizing the at least one phycobilin-based pigment by adding a crystallized agent into the eluant.

3. The method as claimed in claim 1, wherein the calcium phosphate-based compound consists essentially of hydroxyapatite.

4. The method as claimed in claim 3, wherein the plurality of phycobilin-based pigments comprises R-phycoerythrin, and the phosphate elution buffers include a first phosphate elution buffer of which salt concentration ranges from 1 mM up to 25 mM,
wherein in the supplying of the first elution phosphate buffer is supplied into the filling space, and then in the fractionating of the R-phycoerythrin is collected from the eluant corresponding to the first elution phosphate buffer.

5. The method as claimed in claim 3, wherein the plurality of phycobilin-based pigments contain R-phycoerythrin and phycocyanine, and the phosphate elution buffers comprises:
a first phosphate elution buffer of which salt concentration ranges from 1 mM up to 25 mM; and
a second phosphate elution buffer of which salt concentration ranges from 25 mM up to 75 mM;
wherein in the supplying of the first phosphate elution buffer and the second phosphate elution buffer are supplied into the filling space in a stepwise manner in this order, and then in the fractionating of the R-phycoerythrin is collected from the eluant corresponding to the first phosphate elution buffer and the R-phycoerythrin and the phycocyanine are collected from the eluant corresponding to the second phosphate elution buffer in this order.

6. The method as claimed in claim 3, wherein the plurality of phycobilin-based pigments contain R-phycoerythrin, phycocyanine and allophycocyanine, and the phosphate elution buffers comprise:
a first phosphate elution buffer of which salt concentration ranges from 1 mM up to 25 mM;
a second phosphate elution buffer of which salt concentration ranges from 25 mM up to 75 mM; and
a third phosphate elution buffer of which salt concentration ranges from 75 mM up to 250 mM;
wherein in the supplying of the first phosphate elution buffer, the second phosphate elution buffer and the third phosphate elution buffer are supplied into the filling space in a stepwise manner in this order, and then in the fractionating of the R-phycoerythrin is collected from the eluant corresponding to the first phosphate elution buffer, the R-phycoerythrin and the phycocyanine are collected from the eluant corresponding to the second phosphate elution buffer in this order, and the allophycocyanine is collected from the eluant corresponding to the third phosphate elution buffer.

7. The method as claimed in claim 3, wherein the plurality of phycobilin-based pigments comprise R-phycoerythrin, phycocyanine, allophycocyanine and Y-phycoerythrin, and the phosphate elution buffers comprise:
a first phosphate elution buffer of which salt concentration ranges from 1 mM up to 25 mM;
a second phosphate elution buffer of which salt concentration ranges from 25 mM up to 75 mM;
a third phosphate elution buffer of which salt concentration ranges from 75 mM up to 250 mM; and
a fourth phosphate elution buffer of which salt concentration is 250 mM or higher;
wherein in the supplying of the first phosphate elution buffer, the second phosphate elution buffer, the third phosphate elution buffer and the fourth phosphate elution buffer are supplied into the filling space in a stepwise manner in this order, and then in the fractionating of the R-phycoerythrin is collected from the eluant corresponding to the first phosphate elution buffer, the R-phycoerythrin and the phycocyanine are collected from the eluant corresponding to the second phosphate elution buffer in this order, the allophycocyanine is collected from the eluant corresponding to the third phosphate elution buffer, and the Y-phycoerythrin is collected from the eluant corresponding to the fourth phosphate elution buffer.

8. The method as claimed in claim 1, wherein in the sample solution preparing of the sample solution comprises at least one of red algae, blue-green algae, and cryptophyte algae.

9. The method as claimed in claim 1, wherein a pH of each of the phosphate elution buffers ranges from 6 to 8.

10. The method as claimed in claim 1, wherein a temperature of each of the phosphate elution buffers ranges from 30 to 50° C.

11. The method as claimed in claim 2, wherein the crystallized agent consists essentially of ammonium sulfate.
